(19) United States
(12) Patent Application Publication
(10) Pub. No.: US 2003/0121841 A1
(43) Pub. Date: Jul. 3, 2003

(54) Structured membrane

(76) Inventors: Herbert Harttig, Altrip (DE); Carlo Effenhauser, Weinheim (DE)

Correspondence Address: Gregory B. Coy, Woodard, Emhardt, Naughton, Moriarty & McNett LLP, Bank One Center/Tower, 111 Monument Circle, Suite 3700, Indianapolis, IN, 46204-5137, US

(21) Appl. No.: 10/215,396

(22) Filed: Aug. 8, 2002

(30) Foreign Application Priority Data
Aug. 14, 2001 (DE) 101 39 830.1

(51) Int. Cl. B01D 69/06; B01D 69/10

(52) U.S. Cl. 210/321.84; 210/483

(57) ABSTRACT

The invention concerns a flat permeable membrane which has recesses on at least one side which are preferably in the form of channel structures that are considerably larger than the pores of the membrane.

### DESCRIPTION

The invention concerns a flat permeable membrane which has recesses on at least one side which are preferably in the form of channel structures.

It is known that polymer separation membranes can be manufactured in the form of flat membranes or hollow fibre membranes. A large variety of materials and processes are available for this. Flat dialysis membranes from the Gambro, Hospal and Akzo-Enka-Membrana Companies are mentioned as examples. Another example it the highly asymmetric microfiltration membrane from the Memtec Co. which is now US-Filter Memcor. Another example of flat membranes are the nuclear track membranes from Nuclepore.

Miniaturized mass transfer apparatuses containing membranes are manufactured by incorporating fine channels in planar surfaces which are then covered over with a suitable membrane (Lin et al., O.43 3, IMRET 1999). A similar procedure is described in the German Application DE 100 10 587.4; in this case a channel system is also incorporated into a substrate which is covered by an exchange membrane. Hence flow paths are separately manufactured in these devices and then covered by a permeable membrane. This also applies to the case in which the flow paths are provided randomly by fabrics, absorbent fleeces or structured surfaces.

One of the prior art methods according to EP 0 527 905 is also to produce flow paths in flexible polysiloxane elastomer layers that are relatively thick compared to membranes. However, these polysiloxane elastomers are not to be interpreted as porous membranes in the sense of the present invention.

Hence a disadvantage of the miniaturized mass transfer devices according to the prior art is that the channel structures for convective fluid transport are either produced by separate finely structured components, so-called spacers, or by incorporating the channel structures in impermeable support structures. Since the support structures and spacers usually also have to withstand mechanical loads, the manufacture of such incorporated miniaturized structures is time-consuming and associated with a relatively high degree of tool wear.

Hence an object of the present invention was to provide new membranes and mass transfer devices containing these membranes which do not have the disadvantages described above. Furthermore it should be possible to produce these membranes in a simple and reproducible manner.

This object is achieved by a flat permeable membrane which has recesses on at least one side, wherein the dimensions of the recesses exceed the nominal pore size of the membrane by at least five-fold and preferably at least ten-fold.

The nominal pore size of a membrane refers to the diameter of a particle or molecule which passes through the membrane with a probability of 95% (cf. also Marcel Mulder “Basic Principles of Membrane Technology” Kluver Academic Publishers, 1991).

The permeable membrane can on the one hand be a porous membrane i.e. a membrane which has discrete pores. On the other hand, the membrane can be a homogenous solubility membrane without discrete pores in which the mass transport occurs by dissolution of the permeate in the polymer and the separation is due to different solubilities in the polymer. A nominal pore size can also be determined for such permeable membranes.

The recesses can be provided on one or both sides of the membrane and are preferably designed as channel structures. Fluids can be transported convectively through these recesses or channel structures and fluid in the channel structures simultaneously interacts with the membrane surroundings by diffusive or convective mass transfer across the membrane. This is particularly advantageous in miniaturized analytical and reaction systems in which it is necessary to combine microfluidics and microseparation technology.

The invention concerns a flat permeable membrane. The membrane area per se is unlimited. The thickness of the membrane is preferably in the range from 1 μm to 1000 μm and particularly preferably in the range from 10 μm to 200 μm. The nominal pore size of the membrane is preferably in the range from 0.2 nm to 5 μm.

The recesses of the membrane according to the invention preferably have an average diameter of 5-500 μm, particularly preferably of 10-200 μm. The average diameter of the recesses is at least 5-fold and preferably at least 10-fold larger than the nominal diameter of the pores that are responsible for substance separation within the membrane.

The membrane itself has a structure that is already known for various flat membranes. These may be:

gel-like structures such as those of solubility membranes which are used as dialysis membranes,

microporous and macroporous structures,

asymmetric structures that are known for ultrafiltration and microfiltration membranes.

The membranes according to the invention can be composed of known materials. The membrane according to the invention can be composed of a single material or of several materials which are for example arranged in layers. In a preferred embodiment polymer materials are used such as polyacrylamides, polyacrylonitriles, polyamides, polybenzimidazoles, polybutadienes, polycarbonates, polydimethyl-siloxanes, polyethersulfones, polyetherimides, polyolefins, polyethylene terephthalates, polymethylmethacrylates, polymethylpentene, polyphenylene oxide, polystyrene, polysulfones, polyvinyl alcohol, polyvinyl chloride or/and polyvinylidene fluoride. In a another preferred embodiment ceramic materials such as aluminium oxide (Al₂O₂), titanium dioxide (TiO₂) or zirconium oxide are used.

The membranes according to the invention can be used in separation devices and in particular in devices for mass transfer across the membrane. Such devices can for example contain at least one of the membranes according to the invention combined with a non-permeable and preferably planar support. In another embodiment of the invention it is also possible to use two or more and optionally different flat permeable membranes to manufacture a separation device.

The membranes according to the invention are characterized in that after applying the underside of the membrane to a planar support, the channel structures form closed channels. Liquid transport can occur in these channels. Liquid transfer in these channels occurs much more rapidly than liquid transport through the membrane structure at right angles to the channels. The liquid that is transported in these channels can exchange material with another liquid that is located above the membrane. Hence it is possible to carry out for example dialysis, ultrafiltration, nanofiltration or microfiltration. Gas separation is also possible with the device according to the invention. The membrane according to the invention is particularly suitable for carrying out microdialysis.

Another subject matter of the present invention is a process for producing a porous membrane with recesses on at least one side comprising the steps:

(a) preparing a substrate which has protrusions on its surface as a negative for the desired recesses,

(b) applying the membrane material or a precursor thereof onto the substrate and

(c) forming the porous membrane on the substrate.

In order to produce the membrane according to the invention, the desired channel structures are generated in the form of a negative, i.e. as protrusions, on a substrate e.g. a plate, a tape or a drum. This can be achieved by machining or etching methods like the methods used in microelectronic. A layer of a solution or dispersion of the membrane material or of a precursor thereof of the desired thickness is spread onto this substrate. Any membrane-forming polymer solution known in the prior art can be used for this. A polymer membrane is formed by solvent evaporation and/or replacing the solvent with a precipitating agent. It is also possible to use a slurry of a membrane-forming organic polymer containing finely dispersed inorganic particles, preferably Al₂O₃. The latter is known under the name Alceru process (Vorbach, Schulze, Täger; “Herstellung keramischer Hohlmembranen und Filamente nach dem Lyocell Verfahren”; “Keramische Zeitschrift” 50 (3), 176-179, 1988) and (Vorbach, Schulze, Taeger; “Keramische Hohlmembranen, Filamente auf Basis des Alceru Verfahrens”, “Technische Textilien”, Volume 41, November 1988, 188-193).

Membrane formation by so-called phase inversion is well-known. The solvent is extensively removed from the formed membrane by washing it out with non-solvent. After it has completely hardened the membrane is removed from the substrate. The underside of the membrane now has corresponding channel structures in place of the protrusions on the substrate. In the case of ceramic membranes the binder is expelled at this stage and the ceramic particles are sintered.

In order to manufacture mass transfer apparatuses the underside of the membrane can be applied to a planar support and attached in a liquid-tight manner. This is mainly carried out by thermal welding, by adhesives or by means of residual solvent that is present in the membrane and sufficiently solubilizes the surface of the support to make an impermeable adhesive bond.

Completely closed capillaries are formed by joining a structured membrane according to the invention and a planar support. If the capillary openings face the outside, they can be filled with liquid. Liquid can be transported in them. If the upper side of the membrane comes into contact with a solution, mass transfer is possible through the membrane structure between the liquid in the channels and the solution above the membrane.

If there is only a small distance between the channels, a hydraulic short circuit may occur in the case of structures with large pores. In order to prevent this, the membrane structure can be wholly or partially compressed by mechanical or thermal means and thus rendered less permeable to liquid.

If at least two of the membranes described above which have channel structures on the underside are combined, it is possible to construct mass transfer devices which require either no spacers or only a small number of spacers. Especially with membranes that have a very high surface porosity, the unstructured upper sides can be placed on top of one another without incurring any disadvantages and mass transfer can take place from one channel layer into the next channel layer. This enables the construction in particular of miniaturized mass transfer equipment which allow a very high specific exchange capacity. These mass transfer devices also have extremely small dead volumes.

If two of the membranes described above are joined together by the unstructured upper sides, it is possible to obtain a membrane with channel structures on both sides. For this the membranes are preferably placed on top of one another in a state in which adequate amounts of residual solvent are still present in the membranes and are joined together by the action of pressure, temperature or/and residual solvent. The simplest approach is to apply pressure when the two membranes to be joined together are still on the substrate on which the microstructured channels are preformed. The membranes are preferably non-detachably joined together.

An advantage of the inventive solution is that on the one hand, the miniaturized channel structures are produced in a simple moulding process without any strain at all on the tools which probably leads to a long useful life. Another advantage is a high production rate. Yet a further advantage is the variability of the process which allows a wide variety of structures to be combined in an uncomplicated manner. In addition it is possible to construct mass transfer apparatuses which have extremely high specific exchange capacities relative to the volume of the device. Another advantage is that the miniaturized mass transfer devices that can be built with this process have extremely small dead volumes.

The invention is further elucidated by the following examples.

### EXAMPLES

### Example 1

Production of a Polymer Solution

120 g of an aromatic-aliphatic polyamide (Trogamid T, Degussa-Hüls, Germany) was dissolved while stirring together with 55 g polyvinylpyrrolidone with a molecular weight of 3500 (Polidone, BASF AG, Ludwigshafen, Germany) in 825 g N-methylpyrrolidone (Riedel de Haen, order No. 15780) at a temperature of 60° C. in a 2 l stirred flask. The dissolution was completed after 8 hours. The polymer solution was evacuated, allowed to stand overnight and used the next morning.

### Example 2

Production of a Substrate

A silicon wafer which had a diameter of 100 mm served as the substrate on which one-dimensional arrays of 40 parallel ribs having a height of 40 μm, a width of 100 μm, a spacing of 300 μm and a length of 20 mm were generated by a photolithographic process. 5 mm wide zones without ribs remained between the arrays.

### Example 3

Production of a Membrane

The silicon wafer of example 2 was attached to a glass plate. Ca. 20 ml of the polymer solution of example 1 was poured onto the glass plate in front of the wafer and spread into a thin layer by a doctor blade. The doctor blade was adjusted such that the wet layer thickness over the wafer was ca. 240 μm. Immediately after spreading the polymer solution, the glass plate with the wafer and the polymer layer was placed in a water bath at room temperature. The membrane was completely precipitated within a few minutes and could be detached from the wafer.

The membrane was placed twice for 5 min in freshly-distilled water in order to completely remove the solvent. The moist membrane was immersed in a 15% by weight aqueous glycerol solution for 15 minutes, hung vertically and dried overnight at room temperature and 45% relative humidity.

The underside of the membrane had channels with dimensions of 40×100 μm. It had an average thickness of ca. 80 μm. It was divided parallel to the channels in strips of ca. 25 mm width. The cut was placed in the middle of the channel-free region. Membrane wafers were formed from the strips by cutting the strips at right angles to the channel direction at the ends of the channels in such a manner that the end faces of the channels were open.

### Example 4

Preparation of a Mass Transfer Apparatus

A plate made of polymethylmethacrylate (PMMA) was evenly coated with a ca. 10 μm thick layer of an acrylate adhesive (Duroteck 3872825, National Starch, ICI). After evaporating the solvent, a membrane wafer according to example 3 was carefully glued on without bubbles. PMMA strips of 3 mm thickness and 10 mm width with an L-shaped recess of 4 mm×1 mm were glued onto the end faces of the membrane wafer and were sealed from the membrane surface and at the sides with epoxy adhesive (RS Quick set epoxy adhesive, RS Components, Mörfelden-Walldorf, Germany). A tube of 1.0 mm external diameter was glued into the second side. The resulting exchange surface was 14×20 mm.

Water was pumped at a rate of 1 μl/min through the apparatus. After immersing the mass transfer apparatus in an aqueous dye solution (patent blue, Fluka, Order No. 76270; 0.35% by weight) the dye diffused through the membrane and the solution in the outlet tube was coloured.

1. Flat permeable membrane,
characterized in that
it has recesses on at least one side and the dimensions of the recesses exceed the nominal pore size of the membrane by at least 5-fold.

2. Membrane as claimed in claim 1,
characterized in that
the dimensions of the recesses exceed the nominal pore size of the membrane by at least 10-fold.

3. Membrane as claimed in claim 1 or 2,
characterized in that
the recesses are in the form of channel structures.

4. Membrane as claimed in one of the claims 1 to 3,
characterized in that
the recesses have an average diameter of 5-500 μm.

5. Membrane as claimed in one of the claims 1 to 4,
characterized in that
it is composed of a polymer material.

6. Membrane as claimed in one of the claims 1 to 4,
characterized in that
it is composed of a ceramic material.

7. Device especially for mass transfer across a membrane,
characterized in that
it contains at least one flat permeable membrane as claimed in one of the claims 1 to 6 combined with a non-permeable, preferably planar support.

8. Device especially for mass transfer across a membrane,
characterized in that
it contains at least two flat permeable membranes as claimed in claims 1 to 6.

9. Use of a membrane as claimed in one of the claims 1 to 6 or of a device as claimed in one of the claims 7 to 8 in a mass transfer process.

10. Use as claimed in claim 9 for microfiltration, ultrafiltration, dialysis, nanofiltration or gas filtration.

11. Process for producing a membrane as claimed in one of the claims 1 to 6 comprising the steps
(a) preparing a substrate which has protrusions on its surface as a negative for the desired recesses,
(b) applying the membrane material or a precursor thereof onto the substrate and
(c) forming the membrane on the substrate.
